(19) United States
(12) Patent Application Publication
(10) Pub. No.: US 2008/0011899 A1
(43) Pub. Date: Jan. 17, 2008

(54) Light weight vertical takeoff and landing aircraft

(76) Inventor: Aster Amit, Los Angeles, CA (US)

Correspondence Address: Aster Amit, P.O. Box 60423, Pasadena, CA, 91116-6423, US

(21) Appl. No.: 11/825,622

(22) Filed: Jul. 9, 2007

Related U.S. Application Data
(60) Provisional application No. 60/830,722, filed on Jul. 14, 2006.

(51) Int. Cl. B64C 29/00; B64C 15/12; B64D 27/20

(52) U.S. Cl. 244/12.4; 244/54; 244/56

(57) ABSTRACT

A light aircraft capable of vertical takeoff and landing is provided. The aircraft includes landing gear, a fuselage, having a first and a second side, a front, a back, a top and a bottom, a internal and a external section, a tail assembly, including a horizontal stabilizer, a plurality of elevators perpendicular to a longitudinal axis of the fuselage, a vertical stabilizer, and a rudder. Thrust is provided by a first and a second jet engine, located externally on the first and second sides, respectively, providing thrust to the aircraft. A means for controlling the first and second jet engines pivotally rotates the first and second jet engines around an axis perpendicular to the longitudinal axis. Control is provided by an interconnection element, including a first and second end, contacting the first and second jet engines, respectively, the interconnection element including a plurality of interconnection lines, contacting a first gear box, connected to a shaft and a control box.

### PRIORITY

This application is a non-provisional patent application and claims priority to U.S. Provisional Patent Application No. 60/830,722, with a filing date of 14 Jul., 2006.

### BACKGROUND OF THE INVENTION

1) Field of the Invention

The invention relates generally to an aircraft, more specifically to a light aircraft capable of vertical and/or horizontal flight.

2) Discussion of the Related Art

Vertical takeoff and landing (VTOL) aircraft are well known in the art. One of the more recent VTOL aircrafts is the United States V-22 Osprey. The Osprey includes a fuselage having wings extending from opposite sides, and a tail assembly at the rear end of the fuselage. Propulsion power is provided by two engines, one mounted on each end of the wings, including helicopter size rotors. The engines are pivotally mounted on the ends of the wings and must be vertically oriented so that the helicopter type blades extend substantially horizontal like the main rotor of a helicopter. Once the aircraft is airborne, the engines are swung into horizontal position to orient the rotors in vertical position and provide horizontal thrust to the aircraft.

Another VTOL aircraft is the British Harrier Jet. It is well known that the British Harrier aircraft has the ability to vertically takeoff and land, and include forward flight, just like the Osprey, however, the Harrier is non-rotary and includes jet engine diverters for propulsion. Thus, the Harrier has the ability to provide a more rapid vertical takeoff and thrust than that of the V-22 Osprey. However, the Harrier aircraft is expensive to maintain, operate and manufacture. Moreover, the Harrier does not have the ability to transport equipment and people with capabilities of the helicopter.

Other VTOL aircraft include jet engines and rotary blades for horizontal and vertical thrust, respectively. In flying these aircraft, the operator of the aircraft rotates the engine assembly in the vertical position for takeoff, and upon reaching a desired altitude, rotates the assembly in a horizontal position for forward propulsion. However, these aircraft include many of the disadvantages of the Harrier Jet and the Osprey, in that, they include complicated technology, increased production costs, and contain rotary blades making the aircraft noisy and heavy. Moreover, these aircraft include wings, which means the wings have to be made using heavy weight mechanisms and supports to counter the generated force during takeoff, thus contributing to the overall weight of the aircraft.

In general, VTOL aircraft include very complicated designs. They contain unbalanced thrust and include complicated engine mounting and rotating systems, thus becoming expensive to manufacture and maintain. The usage of these systems also make the aircraft very complicated to fly. The rotary VTOL, including the Osprey, is underpowered and cannot attain high forward speeds because it relies on the overhead rotor. More importantly, the rotary VTOL is often heard before it is seen, increasing the risk of death in combat operations.

Hence, there is a need has for a light weight VTOL aircraft capable of vertical short takeoff and landing which functions in a helicopter capacity, but with the power and control of a jet propelled aircraft. The VTOL would include a less complicated design, utilizing less complicated engine mounting and rotating systems. The VTOL aircraft must contain a light fuselage, be easy to operate and must provide maximum storage capacity.

### BRIEF DESCRIPTION OF THE DRAWINGS

The invention is described by way of example with reference to the accompanying drawings wherein:

FIG. 1 is a top view of a light weight vertical takeoff and landing aircraft, with a first and second jet engine in a vertical position.

FIG. 2 is a top view of the light weight vertical takeoff and landing aircraft, with the first and second jet engine in a horizontal position.

FIG. 3 is a side view of the light weight vertical takeoff and landing aircraft, with the first and second jet engine in the horizontal position.

FIG. 4 is a cross sectional view of the first jet engine in the vertical position.

FIG. 5 is a cross section view of the first jet engine in the horizontal position.

FIG. 6 is a top view of a first and second rotational system, including an interconnection element.

FIG. 7 is a top view of the first and second rotational system, including the interconnection element, contacting a first gear box, a shaft and a control box.

### DETAILED DESCRIPTION OF THE INVENTION

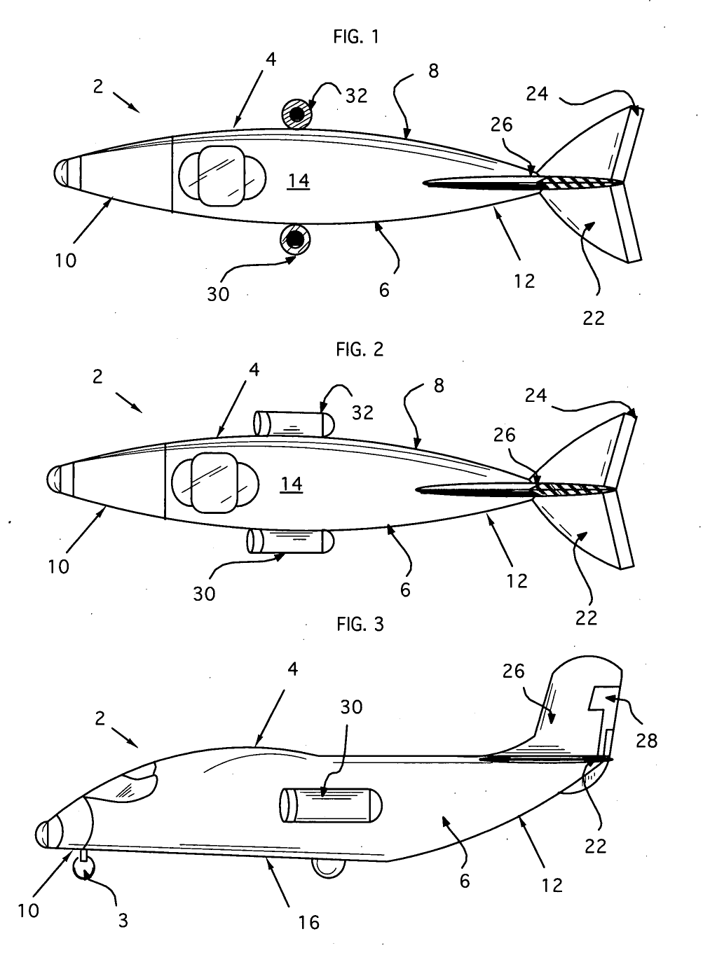

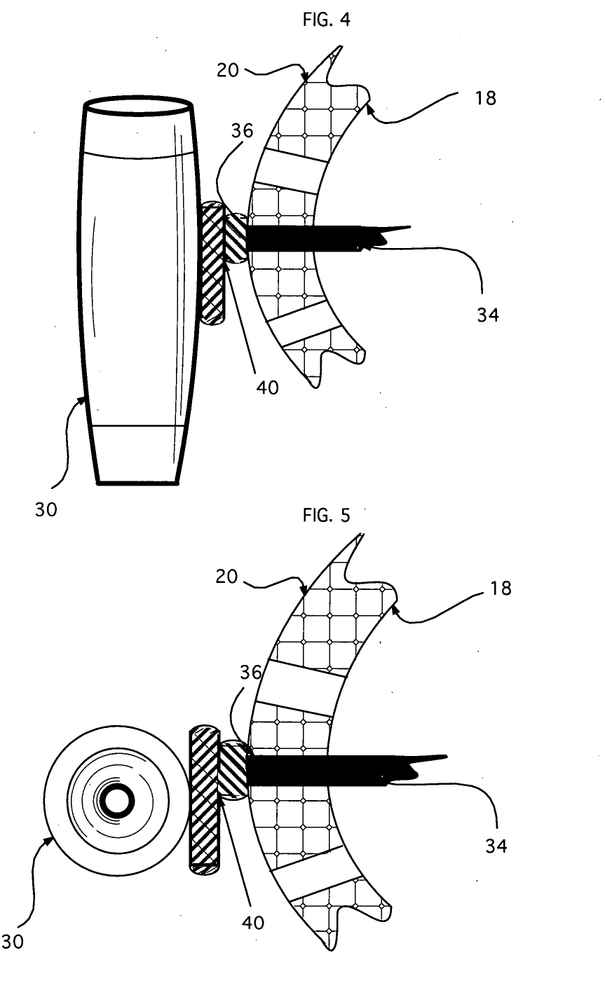

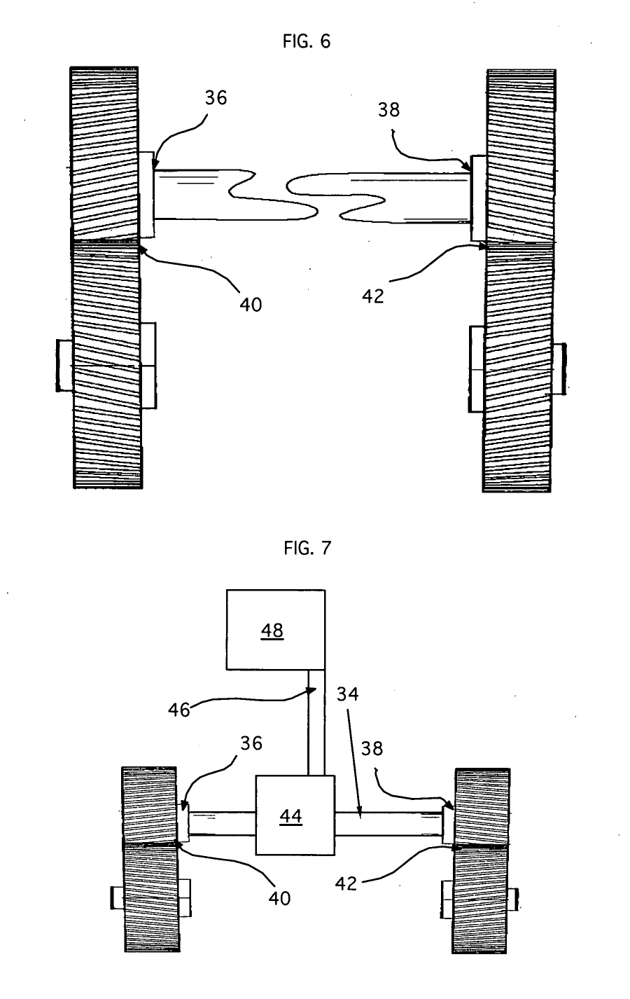

FIGS. 1, 2 and 3 illustrate a light weight vertical takeoff and landing aircraft 2. The aircraft 2 includes landing gear 3, or pontoons for water takeoff and landing, a fuselage 4, having a first and a second side, 6 and 8, respectively, a front 10, a back 12, a top 14 and a bottom 16, an internal section 18 and a external section 20, seen in FIGS. 3 and 4, a horizontal stabilizer 22, including a plurality of elevators 24 perpendicular to a longitudinal axis of the fuselage, a vertical stabilizer 26, including a rudder 28. The aircraft includes a first and a second jet engine, 30 and 32, respectively, located externally on the first and second sides, 6 and 8, respectively, providing thrust to the aircraft 2.

FIG. 1 illustrates the aircraft 2 in vertical flight. The first and second jet engines, 30 and 32, are located on opposite sides of the fuselage 4. The first and second jet engines, 30 and 32, are generally equidistant front a longitudinal axis of the aircraft 2 and are pivotal about a first and second pivot axis, respectively, which are generally perpendicular to the longitudinal axis and front of the center of gravity. The first and second engines, 30 and 32, are rotated in a substantially vertical position, providing aircraft lift, including thrust, overcoming weight and drag.

FIGS. 2 and 3 illustrate the aircraft 2 in horizontal flight. In this flight, the first and second jet engines, 30 and 32, are rotated from a substantially vertical position to a substantially horizontal position, providing forward thrust. The capability of the first and second jet engines, 30 and 32, is such that they can be pivotally rotated at angles between 90 degrees providing for takeoff, landing and forward thrust.

FIG. 4 and 5 illustrate a detailed cross-sectional view of the first jet engine 30 in the vertical and horizontal position, respectively. The figures also illustrate a means for controlling the first jet engine 30, where the first jet engine 30 is mounted to a first rotational system 40. In an embodiment, the first and second jet engines, 30 and 32, are mounted directly to an interconnection element 34, at a first and second end, 36 and 38, respectively.

FIG. 7 and 8 illustrates means for controlling the aircraft 2. FIG. 7 illustrates a detailed view of the first and second rotational systems, 40 and 42. In an embodiment, the rotational systems may be comprised of helical gears, herringbone gears, worm gears or similar gearing systems. The gearing systems provide accurate pivoting around an axis, controlling flight.

FIG. 8 illustrates control of the first and second rotational systems, 40 and 42, and thus the first and second jet engines, 30 and 32. This includes a first gear box 44 contacting the interconnection element 34, a shaft 46 contacting the first gear box 44, and a control box 48 contacting the shaft 46. The control box 48 is controlled by a pilot, which through the shaft 46, controls the first gear box 44, and thus the first and second jet engine, 30 and 32, through the first and second rotational system, 40 and 42.

In use, vertical movement of the aircraft 2, as in a vertical takeoff or landing, the first and second jet engines, 30 and 32, are simultaneously pivoted about their respective axes such that the first and second jet engines are at a substantially 90 degree vertical angle, seen in FIGS. 1 and 4, providing vertical lift. Horizontal movement is accomplished when the first and second engines, 30 and 32, are simultaneously pivoted about their respective axes such that the engines are generally horizontal or in planes generally parallel to the plane of the horizontal stabilizer 22 plane, and are generally parallel to the longitudinal axis of the aircraft 2. This position generates maximum engine efficiency and forward thrust.

The capability of the first and second jet engines, 30 and 32, is such that they can be pivotally rotated at angles between 90 degrees. In an embodiment, the first and second engines, 30 and 32, can be rotated 360 degrees, providing downward thrust during horizontal flight, and reward lift during vertical flight. In an embodiment, the first and second jet engines, 30 and 32, are pivotally rotated by virtue of being mounted directly to the interconnection element 34, at a first and second end, 36 and 38, respectively. In another embodiment, the aircraft 2 contains at least a jet engine towards the back 12 aiding in controlling pitch, yaw and roll. In another embodiment, the first and second jet engines, 30 and 32, are pivotally rotated by a first and second rotational system, 40 and 42. In either embodiment, the first and second jet engines, 30 and 32, may be bolted or otherwise structurally connected to the rotational systems.

The first and second rotational system, 40 and 42, may be comprised of helical, herringbone or worm gears, the rotation of which is accomplished by the control box 48. In an embodiment, helical gears are used on parallel shafts and furnished at a 45° helix angle, which provides a stronger, smoother running gear train. The gears are comprised of hardened steel, steel, stainless, aluminum, bronze, nylon and non-metallic (phenolic). In the embodiment where the first and second rotational systems, 40 and 42, are located external to the fuselage, the gears may be comprised of environmentally protective compositions.

The control of the aircraft 2 is provided by rotating the first and second rotational systems, 40 and 42. The control box 48, manually or electrically contacts the shaft 46, which contacts the first gear box 44, which in turn contacts the interconnection element 34. The first gear box 44, in an embodiment, includes bevel gears. The interconnection element 34 includes interconnection lines such as fuel and electrical lines within a bore, connecting the first and second jet engines, 30 and 32, with the control box 48. In an embodiment, the first and second rotational systems, 40 and 42 are located external to the fuselage 4. In this embodiment, the rotational systems include a protective housing shielding the systems from the outside environmental factors and keeping in gear maintenance compounds.

After random storage within the fuselage 4, a center of gravity is generated. In an embodiment, the rotational systems, 40 and 42, and thus, first and second jet engines, 30 and 32, are adjustable in accordance with a calculated center of gravity, maintaining the stability and maneuverability of the aircraft 2. The interconnection element 34 is slid along a track, or connected to gears and rolled, and secured by a locking mechanism, preventing movement. The center of gravity is calculated according to current software calculating and computer control systems, which, in one embodiment, also controls the maneuverability of the aircraft 2.

The first and second jet engines, 30 and 32, are generally located midline of the fuselage 4. Thus, the stress generated from the engines is placed on the fuselage 4, rather than weaker components. In an embodiment, the jet engines are Turbofan® jet engines. Turbofan® engines are comprised of a fan, compressor, turbine, mixer and nozzle. The fan is draws large quantities of air into the engine compartment. The compressor function is to increases the energy potential by increasing the air pressure in the combustion chamber. Within the combustion chamber the air is mixed with fuel and ignited, causing the turbine to rotate, thus spinning the fan. Thus, the aircraft 2 is able to be controlled by a variable delivery of thrust, by either reducing or increasing the energy potentional within the combustion chamber.

An advantage of the invention is that the fuselage 4 of the aircraft 2 is light, similar to the body of a helicopter and maintains the power of a jet. It achieves this result by using jet engines on the fuselage 2 and not on wings, thus negating the reinforcement and strength structure that would be required in prior aircraft. Thus, the positioning of the engines and the absence of wing structure lightens the overall weight. Also, by placing jet engines on the fuselage 4, the aircraft 2 exhibits a more balanced thrust and control.

The aircraft 2 reduces the complexity involved in maintenance and operation by the components needed to function, and also provides a simple design which is easy to manufacture and assemble. This advantage reduces cost of manufacture and training of individuals in which to fly and repair the aircraft 2. Thus, lowering the overall cost of the aircraft.

Another more apparent advantage of the invention is the elimination of rotary blades from the aircraft 2. The absence of rotary blades contributes to the decrease of weight of the aircraft 2 and complexity of design. The absence of rotary blades also provides an area in which to mount weaponry. However, most obvious is the elimination of the rotary sound, which becomes advantageous in combat situations. Along this same line, are the ease of transportation of equipment and people, and the maximization of cargo space by including the gearing outside the fuselage 4. Given the small light weight fuselage 4, it is imperative that cargo space is maximized.

While certain exemplary embodiments have been described and shown in the accompanying drawings, it is to be understood that such embodiments are merely illustrative and not restrictive of the current invention, and that this invention is not restricted to the specific constructions and arrangements shown and described since modification may occur to those ordinarily skilled in the art.

What is claimed:

1. A light aircraft capable of vertical takeoff and landing, said aircraft including, landing gear, a fuselage, having a first and a second side, a front, a back, a top and a bottom, a internal and a external section, a tail assembly, including a horizontal stabilizer, a plurality of elevators perpendicular to a longitudinal axis of said fuselage, a vertical stabilizer, and a rudder, comprising:
a first and a second jet engine, located externally on said first and second sides, respectively, providing thrust to said aircraft;
an interconnection element, including a first and second end, contacting said first and second jet engines, respectively, said interconnection element including a plurality of interconnection lines; and
means for controlling said first and second jet engines, pivotally rotating said first and second jet engines around an axis perpendicular to said longitudinal axis.

2. The light aircraft of claim 1, wherein said first and second jet engines are positioned substantially equal to a midline of said fuselage.

3. The light aircraft of claim 1, wherein said first and second jet engines are turbofan® engines.

4. The light aircraft of claim 1, wherein said first and second jet engines are mounted to a first and second rotational system, respectively.

5. The light aircraft of claim 4, wherein said first and second rotating systems are located external to said fuselage.

6. The light aircraft of claim 4, wherein said first and second rotational systems are comprised of at least one of helical gears, herringbone gears, or worm gears.

7. The light aircraft of claim 5, wherein said first and second rotational systems include a removable protective housing.

8. The light aircraft of claim 1, wherein said means for controlling said aircraft includes, a first gear box contacting said interconnection element, a shaft contacting said first gear box, and a control box contacting said shaft.

9. The light aircraft of claim 8, wherein said first gear box includes bevel gears.

10. The light aircraft of claim 1, wherein said jet engines are positioned in front of a calculated center of gravity.

11. A pivotally rotating engine assembly, comprising:
a first and a second jet engine;
an interconnection element, including a first and second end, contacting said first and second jet engines, respectively, said interconnection element including a plurality of interconnection lines; and
means for controlling said first and second jet engines, pivotally rotating said first and second jet engines around an axis.

12. The pivotally rotating engine assembly of claim 11, wherein said first and second jet engines are turbofan® engines.

13. The pivotally rotating engine assembly of claim 11, wherein said first and second jet engines are mounted to a first and second rotational system, respectively.

14. The pivotally rotating engine assembly of claim 13, wherein said first and second rotational systems are comprised of at least one of helical gears, herringbone gears, or worm gears.

15. The pivotally rotating engine assembly of claim 13, wherein said first and second rotational systems include a removable protective housing.

16. The pivotally rotating engine assembly of claim 11, wherein said means for controlling said aircraft includes, a first gear box contacting said interconnection element, a shaft contacting said first gear box and a control box contacting said shaft.

17. The pivotally rotating engine assembly of claim 11, wherein said first gear box includes bevel gears.

18. A method of rotating a engine, the method comprising:
rotating in a first direction, a first and a second jet engine, providing vertical thrust, said first and second jet engine contacting a first and second rotational system, respectively, said first and second rotation systems, controlled by a control box connected to a shaft, said shaft contacting a gear box, said gear box rotating an interconnection element contacting said first and second rotational systems; and
rotating in a second direction, said first and second jet engine, after a desired altitude is reached, said first and second jet engine, providing horizontal thrust.

19. A method of controlling a light weight aircraft capable of vertical takeoff and landing, said aircraft including, landing gear, a fuselage, having a first and a second side, a front, a back, a top and a bottom, a internal and a external section, a tail assembly, including a horizontal stabilizer, a plurality of elevators perpendicular to a longitudinal axis of said fuselage, a vertical stabilizer, and a rudder, said method comprising:
rotating in a first direction, a first and a second jet engine on said first and second sides, respectively, providing vertical thrust, located midline of said fuselage, said first and second jet engine contacting a first and second rotational system, respectively, said first and second rotation systems, located externally, controlled by a control box connected to a shaft, said shaft contacting a gear box, said gear box rotating an interconnection element contacting said first and second rotational systems; and
rotating in a second direction, said first and second jet engine, after a desired altitude is reached, said first and second jet engine, providing horizontal thrust.

20. The method of claim 19, wherein said jet engines are positioned in front of a calculated center of gravity.
